(19) United States
(12) Patent Application Publication
(10) Pub. No.: US 2015/0314480 A1
(43) Pub. Date: Nov. 5, 2015

(54) METHOD AND APPARATUS FOR CASTING CONCRETE PRODUCTS

(71) Applicant: Elematic Oy Ab, Akaa (FI)

(72) Inventor: Jani EILOLA, Lempaala (FI)

(73) Assignee: Elematic Oy Ab, Akaa (FI)

(21) Appl. No.: 14/703,958

(22) Filed: May 5, 2015

(30) Foreign Application Priority Data
May 5, 2014 (FI) 20145405

(51) Int. Cl. B28B 17/00; B28B 5/00; B28B 15/00

(52) U.S. Cl. CPC B28B 17/0081; B28B 15/00; B28B 5/00

(57) ABSTRACT

Method and apparatus for casting concrete products, in which method concrete products are cast with a circulating line casting process where casting mold tables are transferred from one workstation to another, wherein the time which a mold table remains in a workstation is determined and stored for further analysis.

This application claims benefit of Finnish Patent Application No. 20145405, filed 5 May 2014, the entire content of which is incorporated herein by reference for all purposes.

### BACKGROUND

1. Field

The present disclosure relates to casting concrete products in molds with a circulating line casting process. More precisely the present disclosure relates to a method and an apparatus for casting concrete products utilizing a circulating line casting process comprising a plurality of casting mold tables movable between different workstations.

2. Description of Related Art

Circulating line casting process is a casting process where the mold tables, on which the casting molds are built, are mounted on tracks and circulate through the phases of the casting process, after which the mold tables are returned for a new cycle.

The circulating line is formed of a plurality of workstations between which the casting mold is transferred in different stages of the casting process. In the first stage of the circulation line the mold table is cleaned. In next stage the mold table is furnished with fixed and detachable mold sidewalls to form the casting mold in the mold table and other required equipment, such as reinforcements etc., are set on the mold. After the furnishing stage casting of the concrete mass to the mold is carried out, together with required vibrating actions during the casting. The casting of concrete mass into the mold can be carried out in different stages if for example different layers need to be added to the product to be cast such as insulation layers in cases of insulated wall elements. When casting of concrete mass to the mold is done, the upper surface of the product to be cast is leveled and other required surface treatment steps are carried out. Next the mold together with the fresh cast product is moved to curing stage, which generally takes place at a curing chamber where temperature during the curing can be monitored and adjusted if required. When the cast product is cured, the mold is taken to demolding, where the mold sidewalls are removed from the mold table after which the cast product is removed from the mold generally together with tilting of the mold. After this stage the mold is ready for new cleaning stage and for the process of casting a new product.

The movement of molds from one workstation to another is generally implemented with manual operation of the transferring equipment after required work steps in the workstation to the mold table are done and the next workstation is ready to receive the mold table, or there is empty buffer zone located after the workstation.

The circulating line casting process may also be equipped with an automatic control system, but this requires that the mold tables are equipped with suitable identification means, such as suitable tags or coding on metal plates, which are read by stationary sensors along the circulating line, so that the location of the mold tables is input to the automatic control system when mold tables pass the sensors. This allows automatic monitoring of the operation of the circulating line casting process by the automatic control system. Further, the automatic control system may be used to provide required materials as well as relating product information to a specific mold and mold table in time for each workstation.

In forced circulation processes, such as circulating line casting process, excess or time consuming work load of a single workstation always affects the efficiency of the whole process by creating bottlenecks in the process. Information and data of these bottlenecks allows for improvement of the whole process, as well as allows possible anticipatory actions in process design.

### SUMMARY

In an embodiment of the invention, time data for each workstation of the circulating line casting process is followed and collected. This collected time data can then be used to identify bottlenecks in the casting process, so that the efficiency of the casting process can be improved.

In an embodiment of the method of the invention, concrete products are cast with a circulating line casting process, where casting mold tables are transferred from one workstation to another, wherein the time which a mold table remains in a workstation is determined and stored for further analysis. This time determination may be implemented by timing the stay of a mold table in a workstation, or the arrival time and departure time of a mold table may be recorded for a workstation and the time which the mold table stayed in the workstation may be determined from these recorded arrival and departure times, for example.

In an embodiment of the method of the invention, the time is preferably determined at each workstation of the circulating line casting process, preferably also for each mold table.

In an embodiment of the method of the invention, the determined times are advantageously analyzed to find bottlenecks in the circulating line casting process, which allows for improvement of the casting process efficiency.

In an embodiment of the method of the invention, the operation of the circulating line casting process is preferably controlled to allow passage of a mold table through all or some of the workstations and the required work steps without additional delays in order to obtain correct time determinations for the time a mold table is worked in a workstation.

Further, in an embodiment of the method of the invention, the time determination for a workstation is preferably carried out only if the next workstation has been free for a predetermined time period or longer than the predetermined time period. The suitable predetermined time may be 1 minute or 30 seconds, for example.

The above two embodiments allow for exact and correct time determination by eliminating other procedural delays which might delay the movement of the mold table from the workstation after the required work steps in that workstation are done.

In an embodiment of the method of the invention, the automatic control system stores the results of the time determinations to a suitable data storing device. This allows for automatic collection of large amounts of statistical time data that allows for better and faster reaction to process bottlenecks even when cast products change continuously.

The automatic collection of the time determination data removes the unreliability related to manual time determinations, as well as the associated costs of additional manual work. Therefore the collected time data is also of better quality and allows for better quality of further analysis based on the collected time data.

The apparatus of an embodiment of the invention comprises a plurality of mold tables and a plurality of workstations forming a circulating line casting process, and an automatic control system for monitoring the casting process, wherein each of the mold tables are equipped with an identification device allowing the automatic control system to detect the location of each of the mold tables, as well as a suitable device or devices for determining the time which a mold table remains in a workstation.

In an embodiment of the apparatus of the invention, the device for determining the time preferably determines the time which each mold table remains in each workstation of the circulating line casting process.

In an embodiment of the apparatus of the invention, the time determination is preferably carried out only in the situation where the mold table may depart from the workstation immediately after the required work in the workstation is done.

In an embodiment of the apparatus of the invention, the automatic control system preferable controls the device for determining the time, and preferably comprises a device, such as one or more data storing devices, for storing the determined times.

The features defining a method according to an embodiment of the invention are disclosed more precisely as a method for casting concrete products, in which method concrete products are cast with a circulating line casting process where casting mold tables are transferred from one workstation to another, characterized in that the time which a mold table remains in a workstation is determined and stored for further analysis.

The features defining an apparatus according to an embodiment of the invention are disclosed more precisely as an apparatus for casting concrete products, which apparatus comprises a plurality of mold tables and a plurality of workstations forming a circulating line casting process, and an automatic control system for monitoring the casting process, wherein each of the mold tables are equipped with an identification device allowing the automatic control system to detect the location of each of the mold tables, characterized in that the apparatus comprises a device for determining the time which a mold table remains in a workstation. Other advantageous embodiments and features of the invention include those wherein:

the time is determined at each workstation of the circulating line casting process, preferably for each mold table;

the determined times are analyzed to find bottlenecks in the circulating line casting process;

the operation of the circulating line casting process is controlled to allow passage of a mold table through all or some of the workstations and the required work steps without additional delays in order to obtain correct time determinations for the time the mold table is worked on in one or more workstations;

the time determination for a workstation is carried out only if the next workstation has been free for a predetermined time period or longer than the predetermined time period;

the operation of the circulating line casting process is monitored with an automatic control system, which carries out the time determinations and stores the results of the time determinations;

the device for determining the time determines the time which each mold table remains in each workstation of the circulating line casting process;

the time determination is carried out only in the situation where the mold table may depart from the workstation immediately after the required work in the workstation is done; and/or

the automatic control system controls the device for determining the time and comprises a device for storing the determined times.

### BRIEF DESCRIPTION OF DRAWING

Exemplifying embodiment of the invention and its advantages are explained in greater detail below in the sense of example and with reference to accompanying drawings, where

FIG. 1 shows schematically a layout of a manufacturing facility with circulating line casting processes utilizing an embodiment of the present invention.

### DETAILED DESCRIPTION OF SPECIFIC EMBODIMENTS

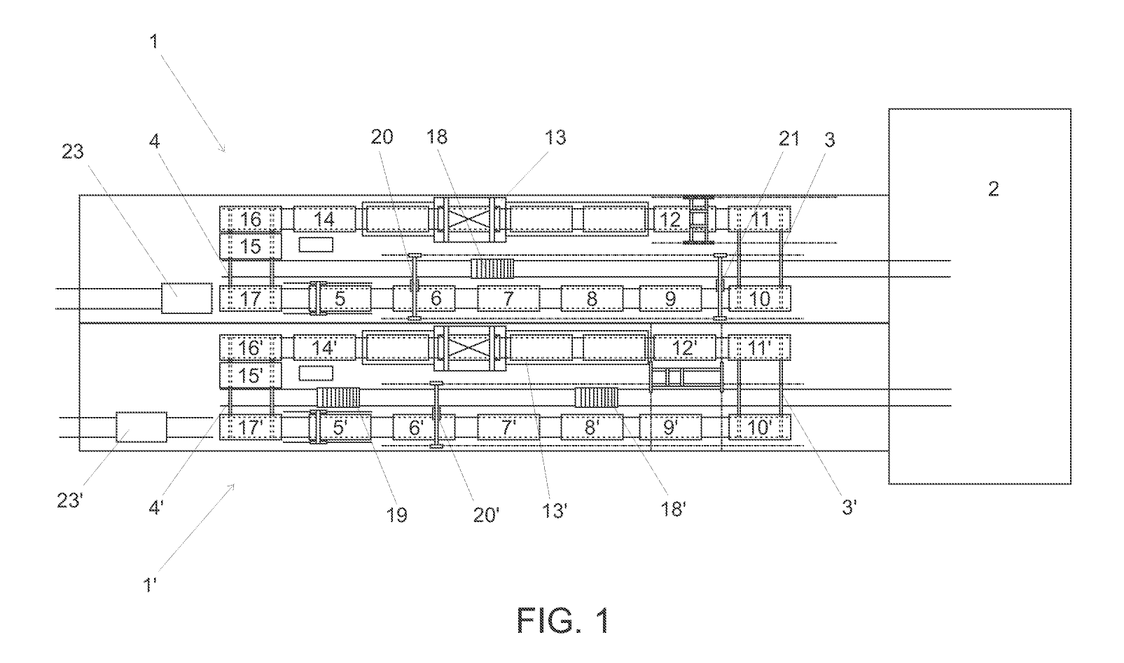

FIG. 1 shows schematically a layout of a manufacturing plant, which comprises two circulating line casting processes 1, 1′ and a reinforcement shop 2.

The circulating line casting processes 1, 1′ comprises plurality of work phases or workstations which are located side by side in the lengthwise direction of the processes in two separate workstation lines, which two workstation lines are connected to each other at transversal transfer tracks 3, 3′ and 4, 4′ located at the both ends of the workstation lines. The mold tables or molds are transferred from one workstation to another along tracks extending along the workstation lines, and from one workstation line to another with the transversal transfer tracks 3, 3′ and 4, 4′.

In the circulating line casting processes 1, 1′, the first work phase carried out in first workstation 5, 5′ is the cleaning of the mold table, after which the mold table is moved to furnishing stage where mold sidewalls are fixed to the mold table to form the casting mold, which is carried out in workstations 6, 6′ and 7, 7′. Once the mold is ready, the required reinforcements are added and in-stalled in the mold in workstations 8, 8′, 9, 9′, 10, 10′ and 11, 11′. Next the casting of the concrete mass is carried out in workstation 12, 12′, after which the molds with cast products are moved to a curing chamber 13, 13′. In the curing chamber 13, 13′ the molds are stacked is stacks so that plurality of concrete products in their molds can be cured simultaneously. Further, the curing chamber is also equipped with separate walls to form enclosed area, and the temperature and humidity inside the curing chamber modified in order to enhance the curing of the concrete products.

In the circulating line process 1′, the casting of the concrete mass into the mold can also be carried in two stages, first at reinforcements workstation 9′ and then casting workstation 12′. This allows casting of insulated wall elements, for example, where the wall element to be cast comprises an insulation layer that is added on top of the first cast concrete layer before another layer of concrete is cast on top of the insulation layer. Both of these concrete layers in the insulated wall element often also require separate reinforcements for each concrete layer.

Once the concrete products in their molds are cured, the molds are moved out of the curing chamber 13, 13′ to workstations 14, 14′ and 15, 15′ for demoulding, where the mold sidewalls are removed from the mold table. Between the demoulding workstations 14, 14′ and 15, 15′ is arranged additional buffer place 16, 16′, which can alternatively also be used as an additional demoulding workstation. In the last phase the cured concrete products are removed from the mold table in workstation 17, 17′, which is implemented by tilting the mold table, fixing lifting hooks to lifting lugs located in the products and lifting the concrete products with a crane from the workstations to a separate removal carriages 23, 23′, the tracks of which are shown in the figure extending from the circulating line casting process lines, and moved to storage. When the cast concrete product is moved from the mold table, the mold table is moved to the workstation 5, 5′ for cleaning and for a new casting process.

The reinforcements added and fixed to the molds are prefabricated in the reinforcement shop 2, and taken to the reinforcement workstations 8, 8′, 9, 9′, 10, 10′ and 11, 11′ of the circulating line casting processes 1, 1′ with carriages 18, 18′, which carriages move along a straight tracks extending from the reinforcement shop to the area inside the circulating line casting processes. There can be more than one carriage located in the same track, as is shown with a carriage 19 in the area located inside the circulating line casting process 1′. The manufacturing facility also comprises bridge cranes 20, 20′ and 21, for lifting and moving reinforcements and other material from the carriages 18, 18′ and 19 to the workstations of the circulating line casting processes 1, 1′.

The transfer of the mold tables from one workstation to the next may be implemented manually, where the transferring equipment is operated manually, or semi-automatically, where the automated transferring operation is started manually, after the required work steps are done in the workstation in question.

The circulating line casting processes 1, 1′ are monitored with an automatic control system (not shown), which follows the location of each mold table through suitable identification devices, such as RFID tags for example, so that the automatic control system can provide each workstation with materials required for the work carried out in that work station at correct time.

Further, the automatic control system also determines the time each mold table remains at each work station. This determination can be done by measuring the time the mold table remains at the workstation, or the arrival and departure times for the mold table may be registered and the time calculated from these registered times. This type of time determination does not, however, take into account the possible delays caused by other work phases of the circulating line casting processes, which might delay the departure of the mold table from a workstation when the required work for the mold table is already done.

Therefore, more preferably, the automatic control system determines the time a mold table remains and is worked at a workstation so, that the circulating line casting process is controlled by the automatic control system so, that the mold table can depart from the workstation in question immediately after the required work at that workstation is carried out, and only in these cases the time for the workstation is determined and registered. This allows for more proper time determination without the effect of delays caused by other work phases and workstation in the forced circulation process.

The collected time data can then be analyzed to identify the bottlenecks in the circulating line casting process and actions can be taken to remove these identified bottlenecks and to enhance the efficiency of the casting process.

The specific exemplifying embodiment of the invention shown in figures and discussed above should not be construed as limiting. A person skilled in the art can amend and modify the embodiment in many evident ways within the scope of the attached claims. Thus the invention is not limited merely to the embodiments described above.

1. A method for casting concrete products, in which method concrete products are cast with a circulating line casting process where casting mold tables are transferred from one workstation to another, comprising determining and storing the time which a mold table remains in a workstation for further analysis.

2. The method according to claim 1, wherein the time is determined at each workstation of the circulating line casting process.

3. The method according to claim 1, further comprising analyzing the determined times to find bottlenecks in the circulating line casting process.

4. The method according to claim 1, further comprising controlling the operation of the circulating line casting process to allow passage of a mold table through all or some of the workstations and the required work steps without additional delays in order to obtain correct time determinations for the time the mold table is worked on in one or more workstations.

5. The method according to claim 1, wherein the time determination for a workstation is carried out only if the next workstation has been free for a predetermined time period or longer than the predetermined time period.

6. The method according to claim 1, further comprising monitoring the operation of the circulating line casting process with an automatic control system, which carries out the time determinations and stores the results of the time determinations.

7. An apparatus for casting concrete products, which apparatus comprises:
a plurality of mold tables,
a plurality of workstations forming a circulating line casting process,
monitoring the casting process, wherein each of the mold tables are equipped with an identification device allowing the automatic control system to detect the location of each of the mold tables, and
a device for determining the time which a mold table remains in a workstation.

8. The apparatus according to claim 7, wherein the device for determining the time determines the time which each mold table remains in each workstation of the circulating line casting process.

9. The apparatus according to claim 7, wherein the time determination is carried out only in the situation where the mold table may depart from the workstation immediately after the required work in the workstation is done.

10. The apparatus according to claim 7, wherein the automatic control system controls the device for determining the time and comprises a device for storing the determined times.

11. The method according to claim 2, wherein the time is determined at each workstation of the circulating line casting process for each work table
